(19) United States
(12) Patent Application Publication
(10) Pub. No.: US 2015/0087193 A1
(43) Pub. Date: Mar. 26, 2015

(54) Linear Conductor Connection Terminal

(71) Applicant: IRISO ELECTRONICS CO., LTD., Kanagawa (JP)

(72) Inventor: Toru Takane, Kanagawa (JP)

(73) Assignee: IRISO ELECTRONICS CO., LTD., Kanagawa (JP)

(21) Appl. No.: 14/483,271

(22) Filed: Sep. 11, 2014

(30) Foreign Application Priority Data
Sep. 25, 2013 (JP) 2013-197782

(51) Int. Cl. H01R 13/629; H01R 13/11

(52) U.S. Cl. CPC H01R 13/629; H01R 13/11
USPC 439/856

(57) ABSTRACT

A housing of a linear conductor connection terminal is provided with a first contact point portion having a recessed portion composed of a metal plate and opening inwardly of the housing. The recessed portion allows insertion of a linear conductor inserted into the housing from an insertion port. The housing is further provided with a second contact point portion that supports contact between the linear conductor and the first contact point portion. This allows the linear conductor to reliably conductively contact the first contact point portion and the second contact point portion.

### BACKGROUND OF THE INVENTION

1. Field of the Invention

The present invention relates to a linear conductor connection terminal that conductively connects between a substrate and a linear conductor such as a cable, for example.

2. Description of the Related Art

There has hitherto been used a linear conductor connection terminal having a housing, an insertion port for insertion of a linear conductor into the housing, and a terminal that conductively connects with the linear conductor as a linear conductor connection terminal that conductively connects between a substrate and a linear conductor such as a cable. In some linear conductor connection terminals, a groove configured to hold the linear conductor is provided in the terminal, and a contact point portion is provided on the same terminal and on the back side away from the groove (see Japanese Unexamined Patent Application Publication No. 2001-332317, for example). In the linear conductor connection terminal, the linear conductor passes inside the groove provided in the terminal to be held between a support force relaxation lever and the terminal to achieve strong conductive connection between the linear conductor and the terminal.

However, the linear conductor connection terminal used for light emitting diode (LED) illumination, for example, is significantly small, and it may be difficult for an operator to manually connect a thin linear conductor to the linear conductor connection terminal. Specifically, when the linear conductor is inserted from the insertion port deep into the housing, the linear conductor may be inserted in a direction that is different from the direction of the contact point portion. In this case, even if it is attempted to guide the linear conductor to the contact point portion using the groove, the linear conductor may not reach the contact point portion unless the linear conductor is inserted straight toward the contact point portion since the contact point portion is provided on the back side away from the groove.

### SUMMARY OF THE INVENTION

The present invention has been made to address the foregoing issue. That is, it is desirable to provide a linear conductor connection terminal that allows a linear conductor such as a cable to reliably reach a contact point portion.

In order to address the foregoing issue, the present invention is configured as follows.

That is, it is desirable to provide a linear conductor connection terminal including a housing having an insertion port for a linear conductor and fixed to a substrate, in which the housing has a first contact point portion having a recessed portion composed of a metal plate and opening inwardly of the housing, the first contact point portion allowing insertion of the linear conductor inserted from the insertion port into the housing through the recessed portion, and a second contact point portion that contacts the linear conductor inserted through the recessed portion to support contact between the linear conductor and the first contact point portion.

With the housing having a recessed portion composed of a metal plate and opening inwardly of the housing, the linear conductor inserted into the housing from the insertion port can be inserted through the recessed portion, and guided to the back side of the housing along the center axis of the linear conductor. Hence, even a linear conductor that is thin and easily bendable, for example, can be reliably inserted deep into the housing through the recessed portion. With the first contact point portion having such a recessed portion, in addition, the first contact point portion and the linear conductor can be reliably conductively connected to each other with the linear conductor kept inside the recessed portion not to move away from the first contact point portion.

In addition, the housing includes a second contact point portion that contacts the linear conductor inserted through the recessed portion to support contact between the linear conductor and the first contact point portion. Hence, the linear conductor can be reliably conductively connected to the linear conductor connection terminal without slipping away from the recessed portion.

In the present invention, the first contact point portion may be formed by bending a part of the metal plate forming the housing into a recessed shape. If the first contact point portion is formed by bending a part of the metal plate forming the housing into a recessed shape, the number of parts can be reduced.

In the present invention, the first contact point portion and the second contact point portion may be formed as a part of the metal plate forming a top surface portion of the housing and a part of the metal plate forming a bottom surface portion of the housing. This reduces the number of parts compared to a case where the first contact point portion and the second contact point portion are provided separately from the top surface portion and the bottom surface portion of the housing.

In the present invention, the first contact point portion may have a coupling portion that has spring elasticity and that connects between the recessed portion and the housing in a cantilever manner along the insertion direction, and the coupling portion may be formed as a part of the metal plate that is integral with the housing and the recessed portion. This allows the recessed portion to reliably elastically contact the linear conductor because of the spring elasticity of the coupling portion. If the coupling portion is formed as a part of the metal plate that is integral with the housing and the recessed portion, in addition, the number of parts can be reduced compared to a case where the coupling portion is formed separately from the housing and the recessed portion.

In the present invention, the first contact point portion may be formed on one surface of the housing, and formed to be inclined toward an inside of the housing from one end side, from which the linear conductor is inserted, to the other end. This allows the linear conductor to be guided into the housing along the inclination of the first contact point portion to be correctly connected to the second contact point portion even if the linear conductor inserted into the housing from the insertion port is directed outwardly of the housing and closer to the one surface on which the first contact point portion is provided.

In the present invention, the first contact point portion and the second contact point portion may be provided opposite to each other across a center axis of the linear conductor inserted into the housing, and formed to be inclined closer to the center axis from a side from which the linear conductor is inserted. This allows an insertion passage for the linear conductor to be tapered by the facing inclination surfaces. Therefore, the inclination surfaces can guide the distal end of the linear conductor to the back side of the housing so that the linear conductor is reliably inserted straight.

In the present invention, the first contact point portion and the second contact point portion may be each formed as an elastic piece that abuts with the linear conductor inserted into the housing to be elastically displaced. This allows the linear conductor to be reliably held by the spring elasticity of the first contact point portion and the second contact point portion.

In the present invention, the recessed portion may have a horizontal wall portion having a contact point edge portion formed by a corner portion of the metal plate that contacts the linear conductor, and a vertical wall portion provided at a side end of the horizontal wall portion to extend along an insertion direction of the linear conductor, the horizontal wall portion and the vertical wall portion may guide the linear conductor inserted from the insertion port to a back side inside the housing, and the contact point edge portion formed by the corner portion of the metal plate may be engaged with the linear conductor to contact the linear conductor.

With the recessed portion having a horizontal wall portion, movement of the linear conductor toward the horizontal wall portion can be regulated with the linear conductor caused to extend along the horizontal wall portion, for example. This allows the linear conductor to be smoothly guided to the back side inside the housing. If the recessed portion also has a vertical wall portion provided along the insertion direction of the linear conductor, in addition, the linear conductor can be caused to extend also along the vertical wall portion. In this way, movement of the linear conductor in directions other than the insertion direction can also be regulated. With the recessed portion having wall portions extending along at least two different directions, it is easy to regulate movement of the linear conductor in an unexpected direction, and the linear conductor can be reliably guided to the back side inside the housing.

In the present invention, the housing may include a lever that displaces at least one of the first contact point portion and the second contact point portion in a direction away from the linear conductor. Operating the lever allows the linear conductor to move away from the first contact point portion or the second contact point portion, which allows the linear conductor to be easily extracted from the linear conductor connection terminal.

In the present invention, the lever may be formed by bending a part of the metal plate forming the housing. If the lever is formed by bending the metal plate, a lever in the shape of a plate spring that is elastically displaceable, for example, can be obtained to facilitate an operation to hold and release the linear conductor. In addition, the number of parts can be reduced by forming the lever and a part of the housing integrally with each other.

In the present invention, the lever may have an operation portion with a width that is larger than an outside diameter of the linear conductor inserted into the housing. This allows the operation portion to protrude from an end side of the linear conductor in the width direction even if the lever and the linear conductor partially overlap each other, for example. Therefore, the lever can be operated at the protruding portion.

In the present invention, at least one of the first contact point portion and the second contact point portion may be formed as an elastic piece by cutting and raising a part of the metal plate forming the lever. This allows at least one of the first contact point portion and the second contact point portion to be easily displaced in a direction away from the linear conductor in conjunction with the lever. With at least one of the first contact point portion and the second contact point portion formed as an elastic piece, in addition, the contact point portion can be caused to elastically contact the linear conductor inserted into the housing.

In the present invention, the first contact point portion may have a contact point edge portion formed by a corner portion of the metal plate that contacts the linear conductor. This allows the contact point edge portion to contact the linear conductor inserted into the housing, for example. Therefore, the first contact point portion can be engaged with the linear conductor to contact the linear conductor, which enhances the force for holding the linear conductor. With the contact point edge portion retaining the linear conductor, in addition, easy extraction of the linear conductor can be suppressed even if a force in the extraction direction is applied to the linear conductor.

In the present invention, the second contact point portion may have a contact point edge portion formed by a corner portion of a metal plate that contacts the linear conductor. This allows the contact point edge portion to contact the linear conductor inserted into the housing, for example. Therefore, the second contact point portion can be engaged with the linear conductor to contact the linear conductor, which enhances the force for holding the linear conductor. With the contact point edge portion retaining the linear conductor, in addition, easy extraction of the linear conductor can be suppressed even if a force in the extraction direction is applied to the linear conductor.

In the present invention, the first contact point portion may have a contact point edge portion formed by a corner portion of the metal plate that contacts the linear conductor, the second contact point portion may have a contact point edge portion formed by a corner portion of a metal plate that contacts the linear conductor, and the contact point edge portion of the first contact point portion and the contact point edge portion of the second contact point portion may be engaged with the linear conductor to contact the linear conductor. This allows the linear conductor to be reliably held, and to stably conductively contact the first contact point portion and the second contact point portion.

In the present invention, the first contact point portion and the second contact point portion may have respective contact point edge portions, and the respective contact point edge portions may be disposed opposite to each other to hold the linear conductor therebetween. This allows the linear conductor to be reliably held. Because the linear conductor is reliably retained when a force in the extraction direction is applied, in addition, the linear conductor is not easily extracted from the first contact point portion and the second contact point portion.

In the present invention, the linear conductor may have an electrically insulating sheath, in which case the insertion port may be formed with such a size that allows insertion of the linear conductor but that does not allow insertion of the sheath. Thus, even if the linear conductor has an electrically conductive sheath, the sheath can be prevented from being inserted through the inside of the linear conductor connection terminal. Hence, contact of the sheath with the first contact point portion or the second contact point portion can be suppressed, and the linear conductor and the linear conductor connection terminal can be reliably conductively connected to each other.

In the present invention, the housing may have a top surface portion and a bottom surface portion, the top surface portion may be at the same height as or proximate in height to an upper end of the sheath of the linear conductor, and the bottom surface portion may be at the same height as or proximate in height to a lower end of the sheath. If the top surface portion is at the same height as or proximate in height to an upper end of the sheath of the linear conductor, the profile of the entire linear conductor connection terminal can be reduced, and it is unlikely that the linear conductor connection terminal projects compared to other parts mounted on a substrate. If the bottom surface portion is at the same height as or proximate in height to a lower end of the sheath, in addition, the linear conductor and the substrate can be easily spaced from each other.

According to the present invention, a linear conductor connection terminal that allows a linear conductor such as a cable to reliably reach a contact point portion can be obtained. In addition, a linear conductor connection terminal that allows conductive connection with a linear conductor to be easily maintained can be obtained.

### BRIEF DESCRIPTION OF THE DRAWINGS

FIG. 1 is a perspective view of a linear conductor connection terminal according to an embodiment of the present invention;

FIG. 2 is a perspective view of the linear conductor connection terminal of FIG. 1 illustrated from the lever side;

FIG. 3 is a front view of the linear conductor connection terminal of FIG. 1;

FIG. 4 is a back view of the linear conductor connection terminal of FIG. 1;

FIG. 5 is a left side view of the linear conductor connection terminal of FIG. 1;

FIG. 6 is a right side view of the linear conductor connection terminal of FIG. 1;

FIG. 7 is a plan view of the linear conductor connection terminal of FIG. 1;

FIG. 8 is a bottom view of the linear conductor connection terminal of FIG. 1;

FIG. 9 is a sectional view of the linear conductor connection terminal taken along the line IX-IX of FIG. 3;

FIG. 10 illustrates a state in which a cable is connected to the linear conductor connection terminal of FIG. 1; and

FIG. 11 illustrates a state in which a lever of the linear conductor connection terminal of FIG. 10 is pressed.

### DESCRIPTION OF THE PREFERRED EMBODIMENTS

A linear conductor connection terminal 1 will be described below with reference to the drawings. The linear conductor connection terminal 1 is mounted on a substrate 3 on which an LED is provided and which is provided in an LED bulb, for example. The linear conductor connection terminal 1 is used to connect the substrate 3 to a circuit substrate (not illustrated) including a lighting device configured to light the LED via a cable 2.

### Embodiment

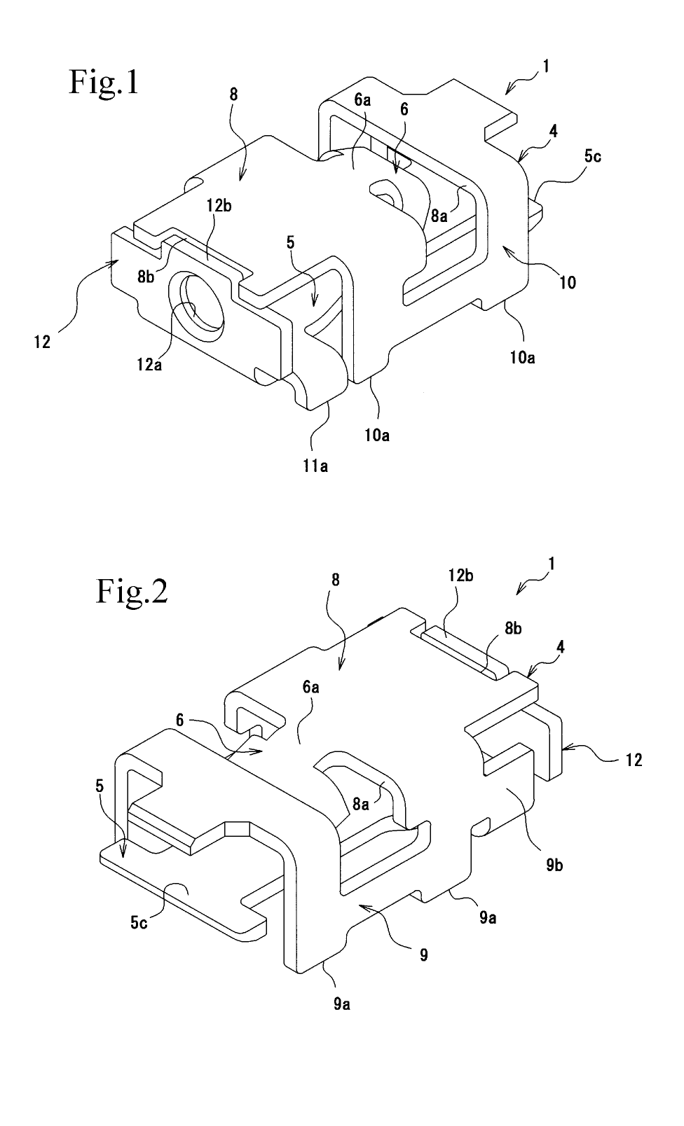

### FIGS. 1 to 11

The linear conductor connection terminal 1 according to the embodiment is a metal terminal that conductively connects between the cable 2 and the substrate 3. The cable 2 includes a linear conductor 2a and an electrically insulating sheath 2b, for example. As illustrated in FIGS. 1 and 2, the linear conductor connection terminal 1 includes a housing 4, a lever 5, a first contact point portion 6, and a second contact point portion 7. The linear conductor connection terminal 1 is formed integrally by bending a conductive metal plate formed by punching.

### (Housing)

As illustrated in FIGS. 1 to 8, the housing 4 is a generally rectangular parallelepiped having a housing space 4a for the linear conductor 2a inside. The housing 4 has a top surface portion 8, a left side surface portion 9, a right side surface portion 10, a bottom surface portion 11, and a front surface portion 12. The back side of the housing 4 which is opposite to the front surface portion 12 is open with no plate surface provided.

The height of the housing 4 from the substrate 3 is 1.8 mm. The respective lengths of the housing 4 in the short direction and the longitudinal direction are 2.9 mm and 5 mm, respectively. The housing 4 is mainly used for the cable 2 with a diameter including the sheath 2b of 1.5 mm.

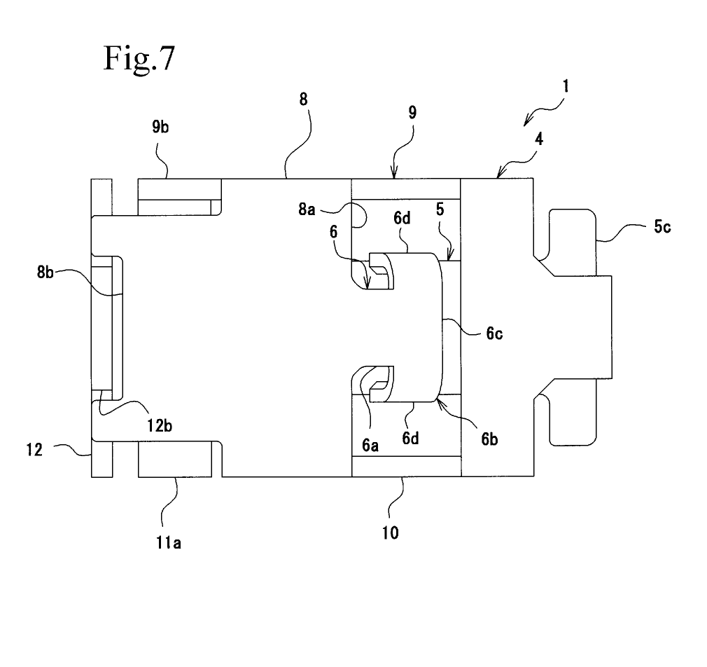

The top surface portion 8 is a plate surface extending in parallel with the substrate 3. As illustrated in FIG. 7, the first contact point portion 6 is formed to hang down generally from the center of the top surface portion 8. A plating hole 8a that faces the top surface portion 8, the left side surface portion 9, and the right side surface portion 10 is provided around the first contact point portion 6. The plating hole 8a facilitates entry of a plating liquid into the housing when plating the linear conductor connection terminal 1. In addition, a recessed portion 8b is provided at the upper end portion of the top surface portion 8 on the front surface portion 12 side.

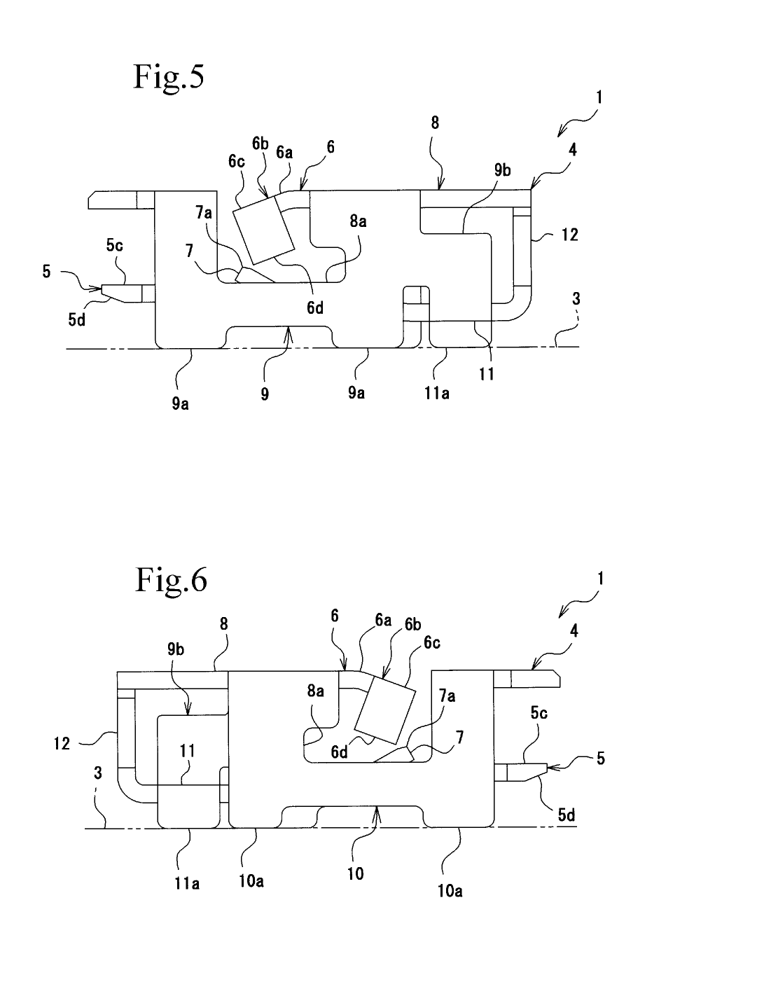

As illustrated in FIGS. 5 and 6, the left side surface portion 9 and the right side surface portion 10 are provided opposite to each other, and bent at the sides along the longitudinal direction of the top surface portion 8 to extend vertically toward the substrate 3. The left side surface portion 9 has two leg portions 9a, 9a provided at the lower end. The right side surface portion 10 has two leg portions 10a, 10a provided at the lower end. The housing 4 is fixed to the substrate 3 by soldering the leg portions 9a, 10a to the substrate 3. In addition, a connection portion 9b is provided on the front side of the left side surface portion 9 to be coupled to the bottom surface portion 11.

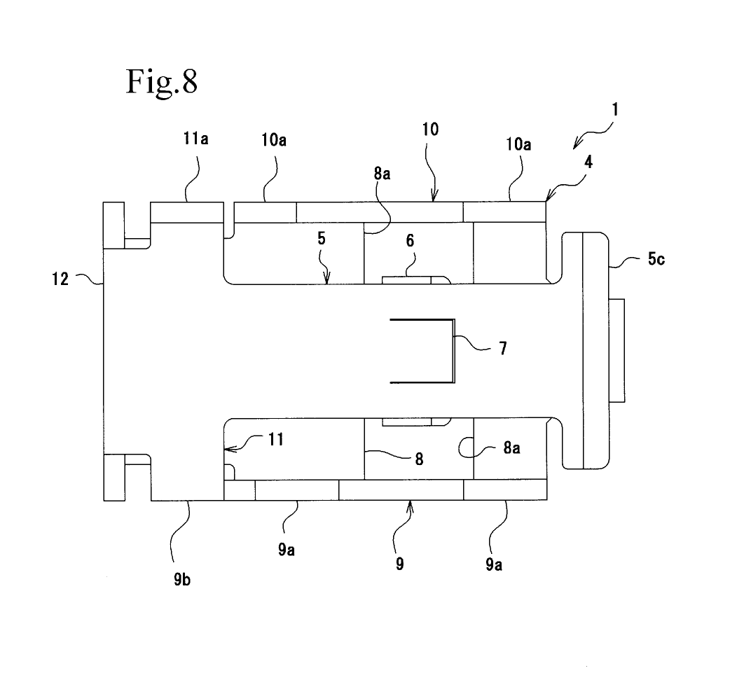

The bottom surface portion 11 is bent at a right angle at the connection portion 9b provided to the left side surface portion 9 to extend generally in parallel with the top surface portion 8. As illustrated in FIG. 8, a fixation portion 11a to be soldered to the substrate 3 is provided on the right side surface portion 10 side of the bottom surface portion 11. The bottom surface portion 11 is supported by the fixation portion 11a and the connection portion 9b. The front surface portion 12 is formed on the front side of the bottom surface portion 11, and bent to extend vertically toward the top surface portion 8. In addition, the lever 5 is provided at the rear end of the bottom surface portion 11 integrally with the bottom surface portion 11. The lever 5 extends in a cantilever manner toward the back side of the housing 4.

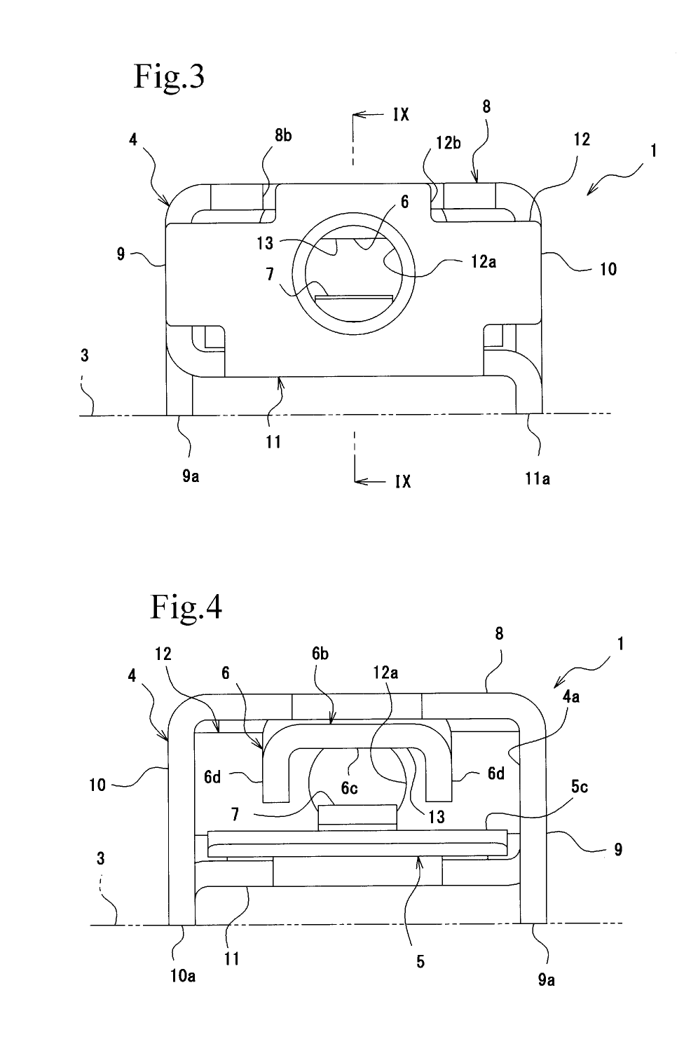

As illustrated in FIG. 3, the front surface portion 12 has a circular insertion port 12 for the linear conductor 2a provided generally at the center. A projecting portion 12b is provided at an end portion of the front surface portion 12 on the top surface portion 8 side. The projecting portion 12b is housed inside the recessed portion 8b of the top surface portion 8.

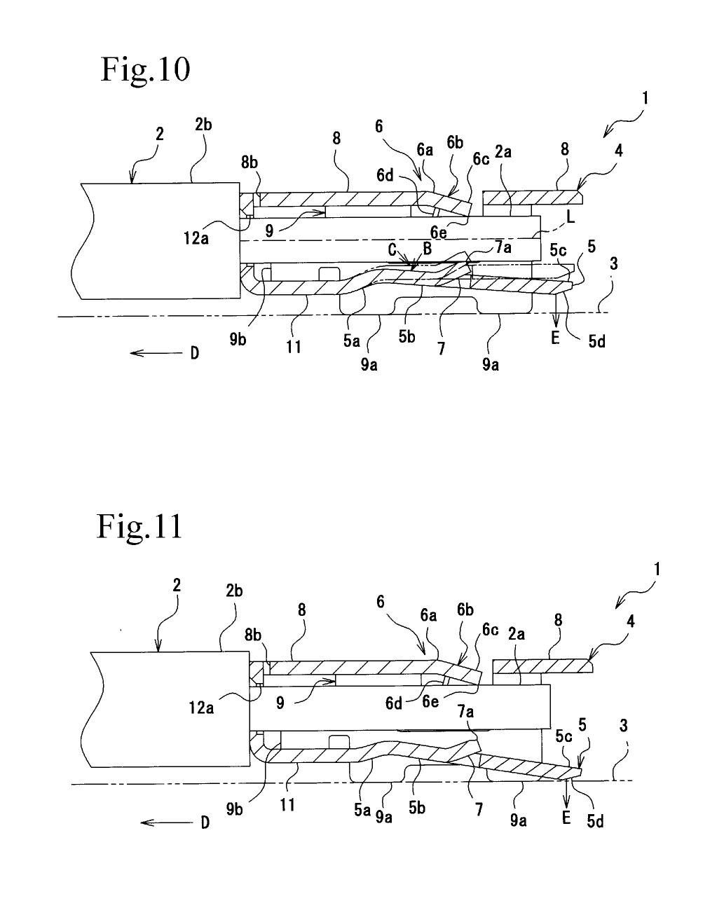

As illustrated in FIG. 10, in addition, the insertion port 12a is provided such that the top surface portion 8 is at the same height as or proximate in height to the upper end of the sheath 2b of the cable 2 with the linear conductor 2a inserted. This prevents the housing 4 mounted on the substrate 3 from projecting compared to other parts mounted on the substrate 3 to hinder mounting of the other parts. In contrast, the insertion port 12a is provided such that the bottom surface portion 11 is at the same height as or proximate in height to the lower end of the sheath 2b of the cable 2. This suppresses contact between the cable 2 and the substrate 3.

### (Lever)

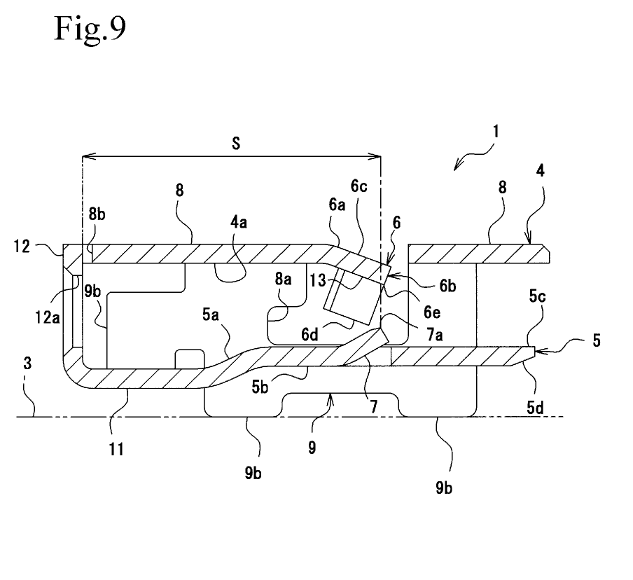

The lever 5 is a cantilever plate spring. As illustrated in FIG. 9, the lever 5 has a bent portion 5a, a displaceable portion 5b, and an operation portion 5c. The bent portion 5a is provided continuously with the bottom surface portion 11, and inclined toward the inside of the housing 4. The displaceable portion 5b is provided on the rear side of the bent portion 5a to extend generally in parallel with the top surface portion 8. In addition, the second contact point portion 7 is provided generally at the center of the displaceable portion 5a. The second contact point portion 7 is formed by cutting and raising a portion of the plate surface to extend toward the inside of the housing 4.

The bottom surface portion 11 provided in front of the lever 5 is supported away from the substrate 3 by the fixation portion 11a provided to the bottom surface portion 11 and the connection portion 9b which connects between the left side surface portion 9 and the bottom surface portion 11. This brings the lever 5 into a free state in which the lever 5 is displaceable inwardly and outwardly of the housing 4 about a portion of the lever 5 on the bottom surface portion 11 side, which allows the lever 5 to be elastically displaced by pressing the operation portion 5c toward the substrate 3. In addition, the operation portion 5c can have a width that is larger than the outside diameter of the linear conductor 2a. This makes it easy for an operator (not illustrated) to operate the operation portion 5c by touching a portion of the operation portion 5c that protrudes from both sides of the linear conductor 2a in the width direction even if the linear conductor 2a inserted into the housing space 4a of the housing 4 from the insertion port 12a overlaps the operation portion 5c. Further, the lever 5 extends along the insertion direction of the linear conductor 2a from the insertion port 12a side. Thus, the lever 5 can reliably have a length enough to be elastically displaced even if the lever 5 is so compact as not to project from the housing 4 in the width direction.

### (First Contact Point Portion)

As illustrated in FIGS. 4 to 7 and 9, the first contact point portion 6 is provided as an elastic piece that is integral with the top surface portion 8 of the housing 4. The first contact point portion 6 has a coupling portion 6a connected to the top surface portion 8, and a recessed portion 6b provided at the distal end side of the coupling portion 6a. As illustrated in FIG. 9, a distance S is provided along the insertion direction of the linear conductor 2a between at least one of the first contact point portion 6 and the second contact point portion 7 and the insertion port 12a. This allows the linear conductor 2a to be held by at least one of the first contact point portion 6 and the second contact point portion 7 and the insertion port 12a provided at a position the distance S away therefrom. Hence, it is easy to keep the linear conductor 2a in parallel with the top surface portion 8 and the bottom surface portion 11 compared to a case where the linear conductor 2a is held at a plurality of positions that are proximate to each other along the insertion direction. Therefore, it is possible to suppress occurrence of damage to or deformation of the linear conductor 2a or the housing 4 due to contact of the linear conductor 2a with the top surface portion 8 or the bottom surface portion 11 from the inside of the housing 4, or application of a significantly large load to only the insertion port 12a, the first contact point portion 6, or the second contact point portion 7. The recessed portion 6b is formed by extending the coupling portion 6a and bending the distal end side toward the inside of the housing 4. In addition, the recessed portion 6b has a horizontal wall portion 6c connected to the coupling portion 6a, and vertical wall portions 6d, 6d provided at both side ends of the horizontal wall portion 6c and bent and projecting toward the inside of the housing 4. The number of parts can be reduced by bending the coupling portion 6a to provide the recessed portion 6b integrally with the coupling portion 6a. Similarly, the number of parts can be reduced by providing the first contact point portion 6 having the recessed portion 6b integrally with the housing 4.

The coupling portion 6a and the recessed portion 6b are inclined toward the inside of the housing 4 to the distal end side of the coupling portion 6a and the recessed portion 6b. The recessed portion 6b is disposed inside the housing space 4a of the housing 4. The coupling portion 6a has spring elasticity, and connects between the recessed portion 6b and the housing 4 in a cantilever manner so that the recessed portion 6b elastically contacts the linear conductor 2a inserted from the insertion port 12a. In addition, the corner portion of the horizontal wall portion 6c of the recessed portion 6b on the bottom surface portion 11 side serves as a contact point edge portion 6e to conductively connect with the linear conductor 2a.

### (Second Contact Point Portion)

As illustrated in FIG. 9, the second contact point portion 7 is provided to be inclined toward the inside of the housing 4 from the base portion to the back side of the housing 4. When the lever 5 is operated to be displaced toward the substrate 3, the second contact point portion 7 is also elastically displaced in the same direction in conjunction with the lever 5. In addition, the second contact point portion 7 is formed as an elastic piece provided by cutting and raising a portion of the lever 5 around the center, and elastically contacts the linear conductor 2a. The corner portion of the second contact point portion 7 on the top surface portion 8 side serves as a contact point edge portion 7a to conductively connect with the linear conductor 2a inserted into the housing space 4a from the insertion port 12a. The contact point edge portion 7a of the second contact point portion 7 is provided opposite to the contact point edge portion 6e of the first contact point portion 6 along the vertical direction of the housing 4. Hence, the second contact point portion 7 holds the linear conductor 2a from both sides in the vertical direction of the linear conductor connection terminal 1 between the first contact point portion 6 and the second contact point portion 7. In addition, movement of the linear conductor 2a in directions other than the insertion direction can be suppressed with the linear conductor 2a inserted through an insertion passage 13 surrounded from all directions by the horizontal wall portion 6c and the vertical wall portions 6d, 6d of the recessed portion 6b and the second contact point portion 7. The number of parts can be reduced by forming the second contact point portion 7 integrally with the lever 5.

### (Connection of Linear Conductor)

First, the linear conductor 2a is inserted into the insertion port 12a, and further advanced deep into the housing 4. As illustrated in FIGS. 3, 4, 9, and 10, the insertion passage 13 is provided on the extension of a center axis L of the linear conductor 2a which has passed through the insertion port 12a. In addition, as illustrated in FIG. 10, the first contact point portion 6 and the second contact point portion 7 are provided opposite to each other across the center axis L. The first contact point portion 6 and the second contact point portion 7 are formed to be inclined toward the center axis L from the side of the insertion port 12a for the linear conductor 2a toward the back side in the insertion direction. Hence, the gap between the first contact point portion 6 and the second contact point portion 7 becomes narrower along the insertion direction of the linear conductor 2a. Therefore, the insertion passage 13 is formed to be tapered toward the back side of the linear conductor 2a. Thus, the gap between the contact point edge portion 6e of the first contact point portion 6 and the contact point edge portion 7a of the second contact point portion 7 is smaller than the outside diameter of the linear conductor 2a. Hence, the distal end of the linear conductor 2a contacts the horizontal wall portion 6c of the recessed portion 6b or the second contact point portion 7 in the course of time. The horizontal wall portion 6c is inclined from the top surface portion 8 side toward the bottom surface portion 11. The second contact point portion 7 is inclined from the bottom surface portion 11 side toward the top surface portion 8. Therefore, the linear conductor 2a which has contacted the horizontal wall portion 6c or the second contact point portion 7 is guided to the recessed portion 6b along the inclination of the horizontal wall portion 6c or the second contact point portion 7. Then, the linear conductor 2a is inserted through the recessed portion 6b to be guided to the back side of the housing 4. The linear conductor 2a can be guided to the back side of the housing 4 with the two vertical wall portions 6d, 6d of the recessed portion 6b regulating movement of the linear conductor 2a in the width direction even if the linear conductor 2a is inserted obliquely so that the insertion direction deviates in the width direction of the housing 4, or the distal end of the linear conductor 2a is bent so that it is difficult to insert the linear conductor 2a straight to the back side of the housing 4.

The length of the horizontal wall portion 6c in the width direction is set to be larger than the outside diameter of the linear conductor 2a, which facilitates insertion of the linear conductor 2a between the vertical wall portions 6d, 6d to contact the horizontal wall portion 6c.

As described above, the gap between the contact point edge portion 6e of the first contact point portion 6 and the contact point edge portion 7a of the second contact point portion 7 is smaller than the outside diameter of the linear conductor 2a. The coupling portion 6a of the first contact point portion 6 and the second contact point portion 7 has spring elasticity, and can be elastically displaced when pushed by the distal end of the linear conductor 2a. In addition, the second contact point portion 7 is provided integrally with the lever 5. Therefore, the bent portion 5a of the lever 5 can be elastically displaced toward the substrate 3 when the distal end portion of the linear conductor 2a presses the second contact point portion 7 (see FIG. 10). This allows the second contact point portion 7 to be displaced toward the substrate 3 from the position indicated by the arrow C to the position indicated by the arrow B in conjunction with the lever 5, which widens the gap between the contact point edge portion 6e of the first contact point portion 6 and the contact point edge portion 7a of the second contact point portion 7 to allow insertion of the linear conductor 2a.

As discussed earlier, the lever 5 is held in a free state in which the lever 5 is displaceable inwardly and outwardly of the housing 4 about a portion of the lever 5 on the bottom surface portion 11 side. As illustrated in FIG. 9, the lever 5 is formed to have generally the same length as that of the top surface portion 8 of the housing 4 in the insertion direction of the linear conductor 2a. In contrast, the second contact point portion 7 is formed by cutting and raising a portion of the lever 5, and shorter than the lever 5. Therefore, the second contact point portion 7 is harder and more difficult to deform and elastically displace than the lever 5. Hence, even if the second contact point portion 7 is pressed by the linear conductor 2a to be elastically displaced, the second contact point portion 7 is restored to the original shape with a strong force. Therefore, the contact point edge portion 7a can be strongly engaged with the linear conductor 2a.

The insertion port 12a is formed along the outer peripheral surface of the linear conductor 2a, and formed with such a size that allows insertion of the linear conductor 2a but that resists insertion of the sheath 2b. As the linear conductor 2a is inserted deeper into the housing 4, an end surface of the sheath 2b abuts with the surrounding portion of the insertion port 12a, which stops insertion of the linear conductor 2a into the housing 4. Hence, the sheath 2b is prevented from being inserted into the housing 4 to contact the first contact point portion 6 and the second contact point portion 7, and the linear conductor 2a can be reliably conductively connected to the first contact point portion 6 and the second contact point portion 7.

The linear conductor 2a is held between the contact point edge portion 6e of the first contact point portion 6 and the contact point edge portion 7a of the second contact point portion 7 while staying inside the recessed portion 6b. As discussed above, the second contact point portion 7 is formed by cutting and raising a portion of the plate surface of the lever 5, and the second contact point portion 7 and the lever 5 are an elastic piece in the shape of a plate spring. Thus, when the linear conductor 2a presses the second contact point portion 7, a reaction force against the linear conductor 2a is generated in both the second contact point portion 7 and the lever 5. This allows the second contact point portion 7 to strongly push the linear conductor 2a against the first contact point portion 6 to hold the linear conductor 2a. The first contact point portion 6 has the recessed portion 6b having the horizontal wall portion 6c and the two vertical wall portions 6d, 6d. Therefore, movement of the linear conductor 2a outwardly of the housing 4 can be regulated by the recessed portion 6b, which makes it difficult for the linear conductor 2a to move away from the first contact point portion 6. In addition, the second contact point portion 7 contacts the linear conductor 2a from the opening side of the recessed portion 6b, which allows the linear conductor 2a to reliably conductively connect with the first contact point portion 6 and the second contact point portion 7. In this event, the contact point edge portions 6e, 7a are engaged with the linear conductor 2a to contact the linear conductor 2a, which enhances the force for holding the linear conductor 2a. Hence, the cable 2 can be prevented from being extracted easily with the contact point edge portions 6e, 7a retaining the linear conductor 2a even if the cable 2 is pulled in the extraction direction (the direction indicated by the arrow D in FIG. 10), and conductive connection with the linear conductor 2a can be maintained easily.

Consequently, the linear conductor 2a is held between the first contact point portion 6 and the second contact point portion 7. In this event, the linear conductor 2a is also supported at the lower end of the insertion port 12a. Thus, the load of the cable 2 including the sheath 2b is applied to the front surface portion 12 in which the insertion port 12a is provided. The housing 4 is provided with the leg portions 9a, 10a soldered to the substrate 3. However, concentration of a stress on the leg portions 9a, 10a is suppressed by providing the fixation portion 11a at a position in proximity to the front surface portion 12 so that the fixation portion 11a supports the load of the cable 2.

### (Extraction of Linear Conductor)

When the lever 5 is pressed toward the substrate 3 (in the direction indicated by the arrow E) as illustrated in FIG. 11 with the linear conductor 2 a contacting the first contact point portion 6 and the second contact point portion 7, the bent portion 5a is elastically displaced toward the substrate 3. Then, the second contact point portion 7 provided to the lever 5 is also displaced toward the substrate 3 in the direction away from the linear conductor 2a. This allows the linear conductor 2a to be pulled out in the extraction direction (the direction indicated by the arrow D in FIG. 11) with the contact point edge portion 7a of the second contact point portion 7 disengaged from the linear conductor 2a.

In addition, an inclined portion 5d inclined in the direction away from the substrate 3 toward the rear is formed on a surface of the operation portion 5c on the substrate 3 side (see FIG. 11). This makes it difficult for the operation portion 5c to contact the substrate 3 when the operation portion 5c is pressed toward the substrate 3 (in the direction indicated by the arrow E). Hence, the operation portion 5c can be pushed down sufficiently until the linear conductor 2a is successfully extracted.

### (Function and Effect of Linear Conductor Connection Terminal According to Embodiment)

With the linear conductor connection terminal 1 according to the embodiment, as described above, the cable 2 can reliably reach the first contact point portion 6 and the second contact point portion 7 by providing the recessed portion 6b and inserting the linear conductor 2a through the recessed portion 6b. In addition, conductive connection with the linear conductor 2a can be maintained easily by holding the linear conductor 2a between the first contact point portion 6 and the second contact point portion 7.

### Modifications of Embodiment

In the linear conductor connection terminal 1 described above, the first contact point portion 6 having the recessed portion 6b is provided to the top surface portion 8, and the second contact point portion 7 is provided by cutting and raising a portion of the lever 5. Conversely, however, the second contact point portion 7 may be provided to the top surface portion 8, and the first contact point portion 6 having the recessed portion 6b may be provided by cutting and raising a portion of the lever 5. In addition, the first contact point portion 6 having the recessed portion 6b may be provided to both the top surface portion 8 and the lever 5. This allows the linear conductor 2a to be held between the two first contact point portions 6 so as to reliably maintain conductive connection between the linear conductor 2a and the linear conductor connection terminal 1.

In the linear conductor connection terminal 1, in addition, the recessed portion 6b has two vertical wall portions 6d. On the contrary, the recessed portion 6b may have only one vertical wall portion 6d. In this case, the linear conductor 2a inserted into the housing space 4a of the housing 4 is guided to the back side by the vertical wall portion 6d, the horizontal wall portion 6c, and an inner surface of the left side surface portion 9 or the right side surface portion 10 of the housing 4. If the inner side of the left side surface portion 9 or the right side surface portion 10 is used in place of the vertical wall portion 6d, the amount of the conductive metal plate used for the linear conductor connection terminal 1 can be reduced.

In the linear conductor connection terminal 1, the lever 5, the first contact point portion 6, and the second contact point portion 7 are provided integrally with the housing 4. However, any of such parts may be provided as separated parts to be incorporated into the housing 4. This allows any of the parts to be replaced in the case where a design change is required for the part or in the case where a partial modification is implemented to accommodate various diameters of the cable 2, for example.

What is claimed is:

1. A linear conductor connection terminal comprising a housing having an insertion port for a linear conductor and fixed to a substrate,
wherein the housing has
a first contact point portion having a recessed portion composed of a metal plate and opening inwardly of the housing, the first contact point portion allowing insertion of the linear conductor inserted from the insertion port into the housing through the recessed portion, and
a second contact point portion that contacts the linear conductor inserted through the recessed portion to support contact between the linear conductor and the first contact point portion.

2. The linear conductor connection terminal according to claim 1,
wherein the first contact point portion is formed by bending a part of the metal plate forming the housing into a recessed shape.

3. The linear conductor connection terminal according to claim 1,
wherein the first contact point portion and the second contact point portion are formed as a part of the metal plate forming a top surface portion of the housing and a part of the metal plate forming a bottom surface portion of the housing.

4. The linear conductor connection terminal according to claim 1,
wherein the first contact point portion has a coupling portion that has spring elasticity and that connects between the recessed portion and the housing in a cantilever manner along the insertion direction, and the coupling portion is formed as a part of the metal plate that is integral with the housing and the recessed portion.

5. The linear conductor connection terminal according to claim 1,
wherein the first contact point portion is formed on one surface of the housing, and formed to be inclined toward an inside of the housing from one end side, from which the linear conductor is inserted, to the other end.

6. The linear conductor connection terminal according to claim 1,
wherein the first contact point portion and the second contact point portion are provided opposite to each other across a center axis of the linear conductor inserted into the housing, and formed to be inclined closer to the center axis from a side from which the linear conductor is inserted.

7. The linear conductor connection terminal according to claim 1,
wherein the first contact point portion and the second contact point portion are each formed as an elastic piece that abuts with the linear conductor inserted into the housing to be elastically displaced.

8. The linear conductor connection terminal according to claim 1,
wherein the first contact point portion has a contact point edge portion formed by a corner portion of the metal plate that contacts the linear conductor,
the second contact point portion has a contact point edge portion formed by a corner portion of a metal plate that contacts the linear conductor, and
the contact point edge portion of the first contact point portion and the contact point edge portion of the second contact point portion are engaged with the linear conductor to contact the linear conductor.

9. The linear conductor connection terminal according to claim 8,
wherein the contact point edge portion of the first contact point portion and the contact point edge portion of the second contact point portion are disposed opposite to each other to hold the linear conductor therebetween.

10. The linear conductor connection terminal according to claim 1,
wherein the recessed portion has
a horizontal wall portion having a contact point edge portion formed by a corner portion of the metal plate that contacts the linear conductor, and
a vertical wall portion provided at a side end of the horizontal wall portion to extend along an insertion direction of the linear conductor,
the horizontal wall portion and the vertical wall portion guide the linear conductor inserted from the insertion port to a back side inside the housing, and
the contact point edge portion formed by the corner portion of the metal plate is engaged with the linear conductor to contact the linear conductor.

11. The linear conductor connection terminal according to claim 1,
wherein the housing includes a lever that displaces at least one of the first contact point portion and the second contact point portion in a direction away from the linear conductor.

12. The linear conductor connection terminal according to claim 11,
wherein the lever is formed by bending a part of the metal plate forming the housing.

13. The linear conductor connection terminal according to claim 11,
wherein the lever has an operation portion with a width that is larger than an outside diameter of the linear conductor inserted into the housing.

14. The linear conductor connection terminal according to claim 11,
wherein at least one of the first contact point portion and the second contact point portion is formed as an elastic piece by cutting and raising a part of the metal plate forming the lever.

15. The linear conductor connection terminal according to claim 1,
wherein the linear conductor has an electrically insulating sheath, and
the insertion port is formed with such a size that allows insertion of the linear conductor but that does not allow insertion of the sheath.

16. The linear conductor connection terminal according to claim 11,
wherein the linear conductor has an electrically insulating sheath, and
the insertion port is formed with such a size that allows insertion of the linear conductor but that does not allow insertion of the sheath.

17. The linear conductor connection terminal according to claim 1,
wherein the housing has a top surface portion and a bottom surface portion,
the top surface portion is at the same height as or proximate in height to an upper end of the sheath of the linear conductor, and
the bottom surface portion is at the same height as or proximate in height to a lower end of the sheath.

18. The linear conductor connection terminal according to claim 11,
wherein the housing has a top surface portion and a bottom surface portion,
the top surface portion is at the same height as or proximate in height to an upper end of the sheath of the linear conductor, and
the bottom surface portion is at the same height as or proximate in height to a lower end of the sheath.
